(19) United States
(12) Patent Application Publication
(10) Pub. No.: US 2025/0144947 A1
(43) Pub. Date: May 8, 2025

(54) IMAGE FORMING DEVICE

(71) Applicant: SEIKO EPSON CORPORATION, Tokyo (JP)

(72) Inventors: Satoshi NAKATA, MATSUMOTO-SHI (JP); Kanji MOMOSE, MATSUMOTO-SHI (JP); Masanari TANAKA, SHIOJIRI-SHI (JP); Hirokazu ANADA, MATSUMOTO-SHI (JP); Katsumi YAMADA, MATSUMOTO-SHI (JP)

(21) Appl. No.: 18/941,320

(22) Filed: Nov. 8, 2024

(30) Foreign Application Priority Data
Nov. 8, 2023 (JP) 2023-190627

(51) Int. Cl. B41J 13/16; B41J 11/00; B41J 13/10; B41J 29/13

(52) U.S. Cl. CPC B41J 13/16; B41J 11/0095; B41J 13/103; B41J 13/106; B41J 29/13

(57) ABSTRACT

A printer includes a transport path along which a medium is transported, a transport unit that transports the medium in a transport direction along the transport path, an ejection head that ejects liquid onto the medium transported along the transport path, a manual insertion feed unit that feeds the manually inserted medium to the transport path, a discharge tray that is disposed downstream of the transport path in the transport direction and on which the medium discharged from the transport path is placed, and a restricting unit that restricts, at a position upstream, in the transport direction, of a position facing the ejection head on the transport path, a downstream movement of the medium manually inserted into the manual insertion feed unit.

The present application is based on, and claims priority from JP Application Serial Number 2023-190627, filed Nov. 8, 2023, the disclosure of which is hereby incorporated by reference herein in its entirety.

### BACKGROUND

### 1. Technical Field

The present disclosure relates to an image forming device.

### 2. Related Art

JP-A-2006-27159 discloses an image forming device including a manual insertion tray to which a medium such as thick paper is manually inserted, an image forming unit that forms an image on the medium, and a paper discharge tray to which the medium on which the image is formed is discharged. The manual insertion tray and the paper discharge tray are provided so as to be opposite to each other with respect to a device main body. Thus, the medium fed from the manual insertion tray is transported to the paper discharge tray without being curved.

However, in a configuration in which the medium is manually inserted and placed, as in the image forming device disclosed in JP-A-2006-27159, there has been a case in which the medium is inserted deeper than a position at which the medium is to be placed, or a case in which insertion of the medium is insufficient. In such a case, since the medium is not normally transported, the medium needs to be re-set.

### SUMMARY

An image forming device includes a transport path along which a medium is transported, a transport unit configured to transport the medium in a transport direction along the transport path, an image forming unit configured to form an image on the medium transported along the transport path, a manual insertion feed unit configured to feed the manually inserted medium onto the transport path, a discharge tray disposed downstream of the transport path in the transport direction and on which the medium discharged from the transport path is placed, and a restricting unit configured to restrict, at a position upstream, in the transport direction, of a position facing the image forming unit on the transport path, a downstream movement of the medium manually inserted into the manual insertion feed unit.

### BRIEF DESCRIPTION OF THE DRAWINGS

FIG. 1 is a perspective view illustrating a front face side of a printer.

FIG. 2 is a perspective view illustrating a back face side of the printer in a state in which a back cover is closed.

FIG. 3 is a perspective view illustrating the back face side of the printer in a state in which the back cover is open.

FIG. 4 is a cross-sectional view illustrating an internal configuration of a housing in a simplified manner.

FIG. 5 is a perspective view illustrating a configuration downstream of a manual insertion feed unit.

FIG. 6 is a perspective view illustrating a configuration of a restricting unit according to a first embodiment.

FIG. 7 is a side view illustrating a configuration of the restricting unit according to the first embodiment in a state in which a stopper is positioned at a restricting position.

FIG. 8 is a side view illustrating a configuration of the restricting unit according to the first embodiment in a state in which the stopper is positioned at a retracted position.

FIG. 9 is a perspective view illustrating a restricting unit according to a second embodiment in the state in which the back cover is closed.

FIG. 10 is a side view illustrating the restricting unit according to the second embodiment in the state in which the back cover is closed.

FIG. 11 is a side view illustrating the restricting unit according to the second embodiment in the state in which the back cover is open.

FIG. 12 is a side view illustrating the restricting unit according to the second embodiment, and illustrating a state in which the stopper is displaced to the retracted position in the state in which the back cover is open.

FIG. 13 is a perspective view illustrating a restricting unit according to a third embodiment in the state in which the back cover is closed.

FIG. 14 is a side view illustrating the restricting unit according to the third embodiment in the state in which the back cover is closed.

FIG. 15 is a side view illustrating the restricting unit according to the third embodiment in a state immediately after the back cover is opened.

FIG. 16 is a side view illustrating the restricting unit according to the third embodiment in a state after a predetermined time period has elapsed since the back cover was opened.

FIG. 17 is a perspective view illustrating the back face side of the printer according to a modified example in the state in which the back cover is open.

FIG. 18 is a plan view illustrating a stopper of the printer according to a modified example.

FIG. 19 is a plan view illustrating a stopper of the printer according to a modified example.

FIG. 20 is a plan view illustrating a stopper of the printer according to a modified example.

### DESCRIPTION OF EMBODIMENTS

### 1. First Embodiment

A printer 1 of a first embodiment will be described below.

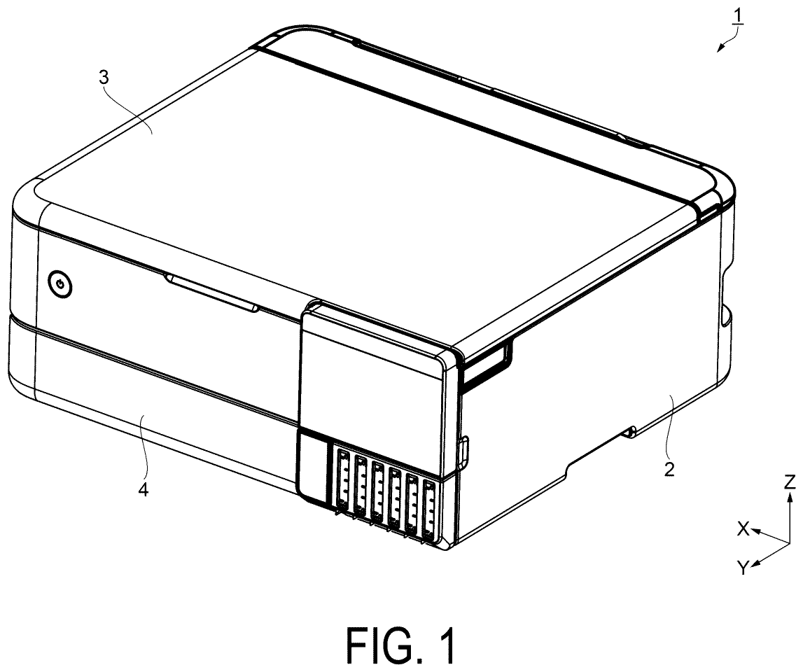

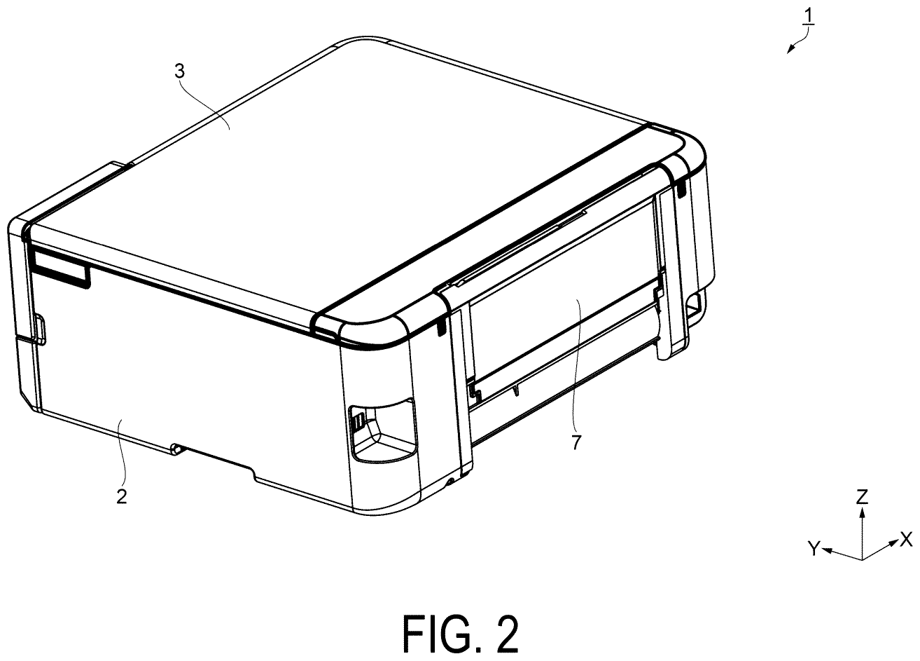

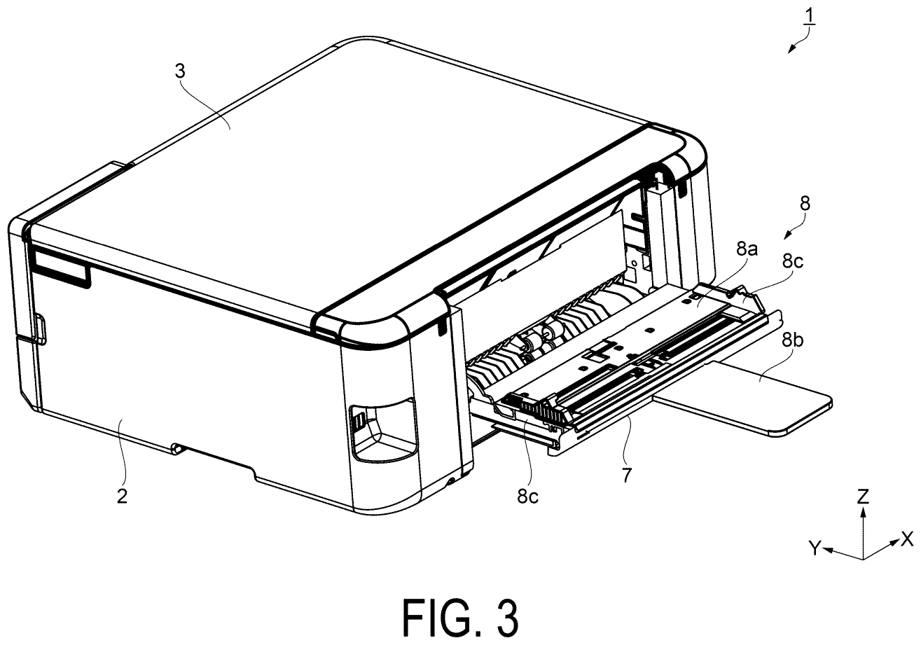

FIGS. 1 to 3 are perspective views of the printer 1. FIG. 1 is a view illustrating a front face side of the printer 1, and FIGS. 2 and 3 are views illustrating a back face side of the printer 1. FIG. 2 illustrates a state in which a back cover 7 is closed, and FIG. 3 illustrates a state in which the back cover 7 is open.

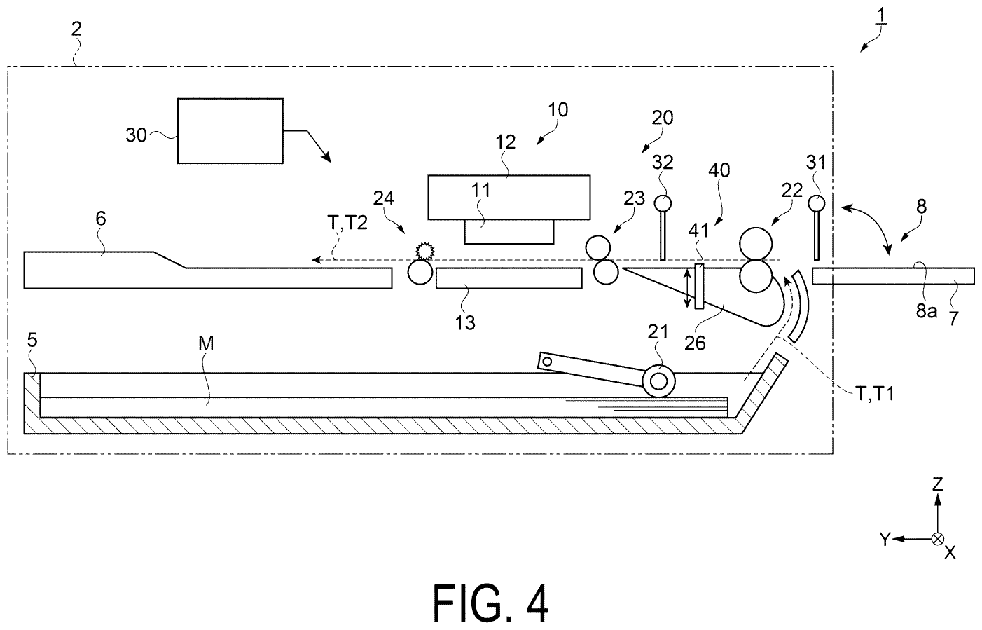

The printer 1 is an inkjet printer, and performs printing, that is, formation of an image by discharging liquid represented by ink onto a medium M (see FIG. 4) represented by recording paper. The printer 1 is an example of an image forming device. The printer 1 according to this embodiment is a multi-functional machine that includes a scanner unit at an upper portion thereof.

Each drawing illustrates X-, Y-, and Z-axes that intersect with one another. In this embodiment, The X-axis, the Y-axis and the Z-axis are orthogonal to each other. The X-axis is parallel to an installation surface of the printer 1, and corresponds to a width direction of the printer 1. The Y-axis is an axis parallel to the installation surface of the printer 1, and corresponds to a depth direction of the printer 1. The Z-axis is perpendicular to the installation surface of the printer 1, and corresponds to a height direction of the printer 1.

Hereinafter, a +X direction parallel to the X-axis is a leftward direction when viewed facing the front face of the printer 1. A −X direction parallel to the X-axis is a direction opposite to the +X direction. A +Y direction parallel to the Y-axis is a direction from the back face toward the front face of the printer 1. A −Y direction parallel to the Y-axis is a direction opposite to the +Y direction. A +Z direction parallel to the Z axis is an upward direction from the installation surface of the printer 1. A −Z direction parallel to the Z-axis is a direction opposite to the +Z direction. In this embodiment, the +Z-axis directions are parallel to the vertical direction.

The printer 1 includes a housing 2 that constitutes an outer casing. An upper cover 3 that can be opened and closed with respect to the housing 2 is disposed on the upper surface of the housing 2. When the upper cover 3 is opened, a document table of a scanner unit (not illustrated) is exposed. A user can cause the scanner unit to read a document by placing the document on the document table.

A front cover 4 that can be opened and closed with respect to the housing 2 is disposed on the front face of the printer 1. When the front cover 4 is opened, a medium storage cassette 5 (see FIG. 4) that stores the medium M before printing, and a paper discharge tray 6 (see FIG. 4) on which the medium M after printing is placed appear.

The back cover 7 that can be opened and closed with respect to the housing 2 is disposed on the back face of the housing 2. The back cover 7 is rotatable by approximately 90° about a rotation axis extending along the X-axis. The user can open the back cover 7 by rotating the back cover 7 to cause an upper portion of the back cover 7 in the closed state to fall down in the −Y direction. When the back cover 7 is opened, a manual insertion feed unit 8 disposed on the back side of the back cover 7 appears. That is, when the back cover 7 is in the closed state, the back cover 7 covers the manual insertion feed unit 8. The manual insertion feed unit 8 is used when printing is performed on the medium M of a different type from the medium M stored in the medium storage cassette 5. The manual insertion feed unit 8 feeds the medium M manually inserted by the user, to a transport path T (see FIG. 4) described later. The back cover 7 is an example of an opening and closing portion.

The manual insertion feed unit 8 includes a placement surface 8a, which is substantially parallel to the XY plane in the state in which the back cover 7 is open. The medium M, which serves as an object to be printed, is placed on the placement surface 8a. The manual insertion feed unit 8 includes an auxiliary plate 8b that can protrude in the −Y direction. The auxiliary plate 8b can be stored inside the manual insertion feed unit 8, and is pulled out by the user when a relatively large medium M is placed in the manual insertion feed unit 8. In a state in which the auxiliary plate 8b is pulled out, the upper surface of the auxiliary plate 8b is regarded as a part of the placement surface 8a. In addition, a pair of side edge restricting units 8c, which restrict the position of the medium M in the ±X directions, is disposed on the placement surface 8a.

FIG. 4 is a cross-sectional view illustrating an internal configuration of the housing 2 in a simplified manner.

As illustrated in FIG. 4, the medium storage cassette 5 that can store a plurality of the media M is disposed on the lower side of the housing 2. The medium storage cassette 5 is detachable from the housing 2. When storing the media M in the medium storage cassette 5, the user takes out the medium storage cassette 5 from the housing 2. Then, after storing the media M in the medium storage cassette 5, the medium storage cassette 5 is mounted to the housing 2. Inside the medium storage cassette 5, the plurality of media M are stacked in a posture substantially parallel to the XY plane.

The printer 1 includes a control unit 30. The control unit 30 includes is a processor such as a central processing unit (CPU), and a storage device such as a memory. The control portion 30 controls operations of the printer 1 in accordance with a program stored in the storage device.

The printer 1 includes a recording unit 10. The recording unit 10 includes an ejection head 11 that serves as an image forming unit, and a carriage 12. The ejection head 11 ejects liquid onto the medium M transported along the transport path T. The carriage 12 holds the ejection head 11 and can reciprocate along the X-axis using a moving mechanism (not illustrated). The ejection head 11 forms an image on the medium M by ejecting the liquid while reciprocating along the X-axis together with the carriage 12. A platen 13 that supports the medium M from below is disposed on the −Z direction side of the ejection head 11. The ejection head 11 ejects the liquid onto the medium M on the platen 13.

The printer 1 includes a transport unit 20. The transport unit 20 includes a paper feed roller 21, a first roller pair 22, a second roller pair 23, and a third roller pair 24. The transport unit 20 transports the medium M along the transport path T. Specifically, the transport unit 20 transports the medium M stored in the medium storage cassette 5 and the medium M placed in the manual insertion feed unit 8, to a position facing the ejection head 11, and transports the medium M after printing toward the paper discharge tray 6. Each of the first roller pair 22, the second roller pair 23, and the third roller pair 24 includes a pair of upper and lower rollers, and the medium M is nipped and transported by the two rollers. One of the pair of rollers is rotationally driven by a driving device (not illustrated).

The printer 1 includes the transport path T that is a path along which the medium M is transported. The transport path T is defined by the paper feed roller 21, the first roller pair 22, the second roller pair 23, the third roller pair 24, the platen 13, a guide member 26 described later, and the like. In this embodiment, the transport path T includes an inversion path T1 along which the medium M stored in the medium storage cassette 5 is transported, and a common transport path T2 along which both the medium M stored in the medium storage cassette 5 and the medium M placed in the manual insertion feed unit 8 are transported. In the following description, a direction in which the medium M is transported along the transport path T will be also referred to as a “transport direction”. In the common transport path T2, the transport direction is the +Y direction. Hereinafter, downstream and upstream in the transport direction will be also simply referred to as “downstream” and “upstream”.

The paper feed roller 21 rotates in a state of being in contact with the medium M stored in the medium storage cassette 5, thereby sending the uppermost medium M toward the first roller pair 22. A path from the medium storage cassette 5 to the first roller pair 22 is the inversion path T1. The inversion path T1 is a path curved so as to be convex in the −Y direction, and the medium M is inverted by approximately 180° in the inversion path T1.

The first roller pair 22 is provided downstream of the paper feed roller 21 and downstream of the manual insertion feed unit 8, that is, on the +Y direction side of the manual insertion feed unit 8. The first roller pair 22 transports the medium M transported from the medium storage cassette 5 and the medium M placed in the manual insertion feed unit 8, in the +Y direction toward the second roller pair 23. The first roller pair 22 is disposed upstream of a second detector 32 described later. The first roller pair 22 is an example of a transport roller pair.

The second roller pair 23 is provided downstream of the first roller pair 22 and upstream of the ejection head 11. The second roller pair 23 transports the medium M in the +Y direction toward the position facing the ejection head 11. An image is formed on the transported medium M by the ejection head 11.

The third roller pair 24 is provided downstream of the ejection head 11. The third roller pair 24 transports the medium M after printing toward the paper discharge tray 6. A path from the first roller pair 22 to the paper discharge tray 6 is the common transport path T2. The common transport path T2 is a path located downstream of the inversion path T1. That is, the paper discharge tray 6 is disposed downstream of the common transport path T2, that is, downstream of the transport path T. The medium M discharged from the transport path T is placed on the paper discharge tray 6. The paper discharge tray 6 is an example of a discharge tray.

As described above, since the inversion path T1 is curved along which the medium M stored in the media storage cassette 5 passes, the medium M, which is relatively flexible and can pass through the inversion path T1, is stored in the media storage cassette 5. On the other hand, since the common transport path T2 is linear along which the medium M placed in the manual insertion feed unit 8 is transported, the manual insertion feed unit 8 is used when printing is performed on the medium M that is relatively inflexible, such as thick paper.

A first detector 31 that detects the medium M is disposed downstream of the manual insertion feed unit 8 and upstream of the first roller pair 22. The first detector 31 is constituted, for example, by a contact sensor, and detects the medium M placed on the placement surface 8a of the manual insertion feed unit 8. A detection result of the first detector 31 is output to the control unit 30. The control unit 30 determines whether or not the medium M is placed in the manual insertion feed unit 8 based on the detection result of the first detector 31.

A second detector 32 for detecting a downstream end portion of the medium M is disposed downstream of the first roller pair 22 and upstream of the second roller pair 23. That is, the second detector 32 is disposed upstream of the position facing the ejection head 11 on the transport path T. The second detector 32 is constituted, for example, by a contact sensor, and detects the medium M transported by the first roller pair 22. A detection result of the second detector 32 is output to the control unit 30. The control unit 30 identifies the position of the downstream end portion of the medium M, based on a timing at which the second detector 32 detects the medium M. The control unit 30 can also identify the position of an upstream end portion of the medium M, based on a timing at which the second detector 32 stops detecting the medium M. The first detector 31 and the second detector 32 are not limited to the contact sensors, and may be, for example, optical sensors. The second detector 32 is an example of a medium detector.

Between the first roller pair 22 and the second detector 32, at a position downstream of the first roller pair 22 and upstream of the second detector 32, a stopper 41 constituting a restricting unit 40 is disposed. At a position upstream of the position facing the ejection head 11 on the transport path T, the restricting unit 40 uses the stopper 41 to restrict a downstream movement of the medium M manually inserted into the manual insertion feed unit 8. The stopper 41 is movable in up-down directions, that is, in the ±Z directions. Specifically, the stopper 41 is displaceable between a restricting position on the ±Z direction side and a retracted position on the −Z direction side. When the stopper 41 is at the restricting position, an upper end portion of the stopper 41 enters the common transport path T2 and restricts the movement of the medium M. On the other hand, when the stopper 41 is at the retracted position, the upper end portion of the stopper 41 is retracted from the common transport path T2, and the medium M can be transported along the common transport path T2. In this way, the restricting position is a position at which the movement toward downstream, of the medium M is restricted, and the retracted position is a position at which the movement toward downstream, of the medium M is not restricted. The restricting position is an example of a first position, and the retracted position is an example of a second position.

When the medium M is placed in the manual insertion feed unit 8, if the downstream end portion of the medium M is placed to be positioned upstream of the first roller pair 22, the medium M cannot be transported by the first roller pair 22. In addition, if the downstream end portion of the medium M is placed to be positioned downstream of the second detector 32, the control unit 30 cannot identify the position of the downstream end portion of the medium M, and printing cannot be performed at a correct position. Therefore, the user needs to place the medium M such that the downstream end portion of the medium M is positioned downstream of the first roller pair 22 and upstream of the second detector 32.

Thus, the control unit 30 displaces the stopper 41 to the restricting position before the medium M is placed in the manual insertion feed unit 8. In this case, the user can place the medium M at an appropriate position by inserting the medium M until the downstream end portion of the medium M passes through the first roller pair 22 and comes into contact with the stopper 41. When printing is performed on the medium M placed in the manual insertion feed unit 8, the control unit 30 displaces the stopper 41 to the retracted position before the first roller pair 22 transports the medium M. Further, when printing is performed on the medium M stored in the medium storage cassette 5, the control unit 30 also displaces the stopper 41 to the retracted position.

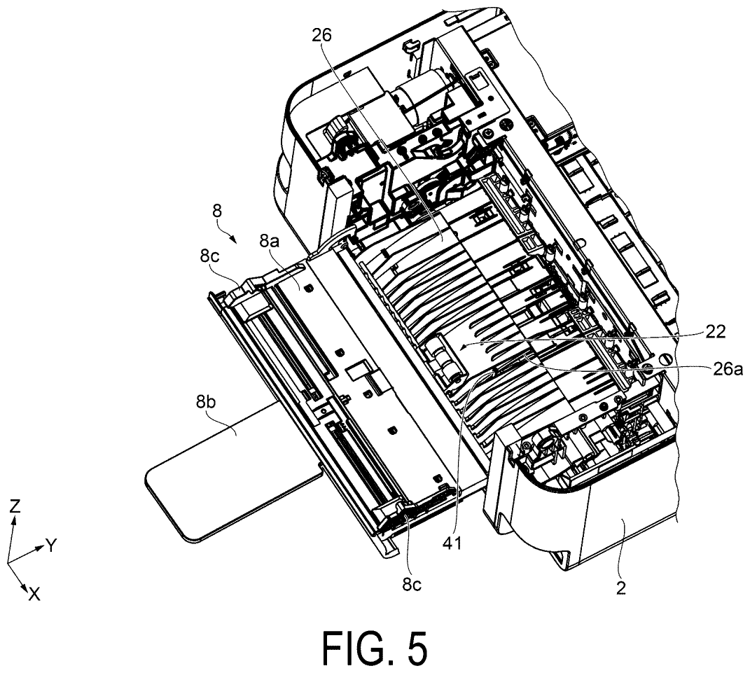

FIG. 5 is a perspective view illustrating a configuration downstream of the manual insertion feed unit 8.

As illustrated in FIG. 5, the guide member 26 that defines the transport path T is disposed downstream of the manual insertion feed unit 8. In this embodiment, the guide member 26 rotatably supports the lower roller of the first roller pair 22. A notch 26a penetrating the guide member 26 in the ±Z directions is formed in the guide member 26, and the stopper 41 can protrude upward through the notch 26a.

The guide member 26 is configured to be detachable from the housing 2. In this way, when a paper jam or the like occurs in the vicinity of the guide member 26, workability for removing the jammed medium M is improved. The notch 26a of the guide member 26 extends from the position at which the stopper 41 is disposed, to an end portion of the guide member 26 on the +Y direction side. Thus, when removing the guide member 26, the guide member 26 can be pulled out in the −Y direction without being hindered by the stopper 41.

Further, the stopper 41 is disposed at a central portion, of the guide member 26, in the direction along the X-axis. In this way, when the medium M is inserted from the manual insertion feed unit 8 toward the stopper 41, a central section, of an end side of the medium M, in the width direction comes into contact with the stopper 41, and it is thus possible to suppress the skew of the medium M when the medium M comes into contact with the stopper 41. In addition, the guide member 26 can be easily pulled out from the stopper 41.

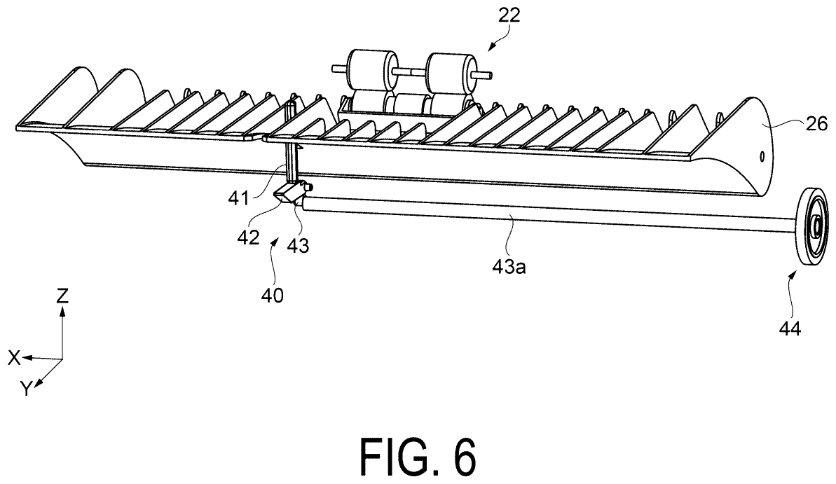

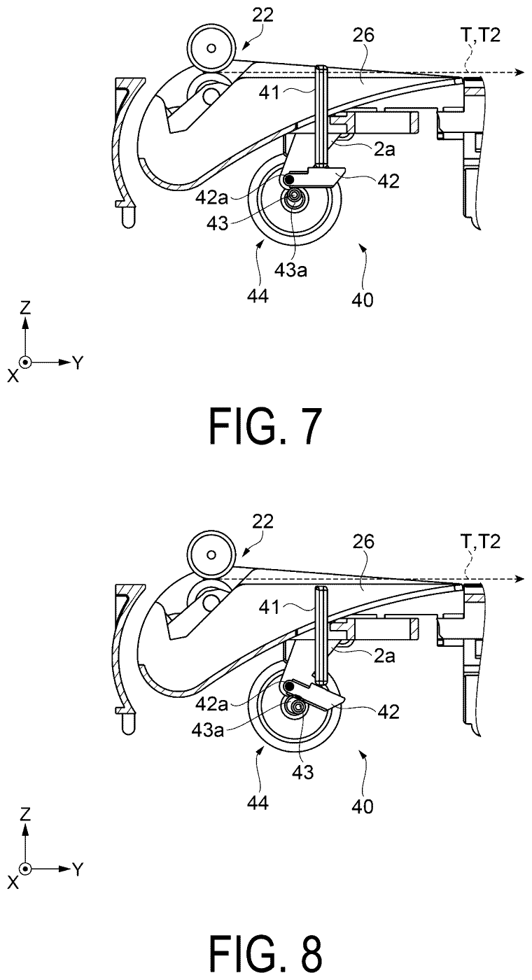

FIG. 6 is a perspective view illustrating a configuration of the restricting unit 40. FIGS. 7 and 8 are side views illustrating the configuration of the restricting unit 40. FIG. 7 is a view illustrating a state in which the stopper 41 is positioned at the restricting position, and FIG. 8 is a view illustrating a state in which the stopper 41 is positioned at the retracted position.

As illustrated in FIGS. 6 to 8, the restricting unit 40 includes the stopper 41, a lever portion 42, an eccentric cam 43, and a driving unit 44.

The stopper 41 has a rod shape and is disposed along the Z-axis. The stopper 41 is movable in the ±Z directions, but the movement of the stopper 41 in other directions is restricted by the guide member 26 and the like.

The lever portion 42 is rotatably supported by a structure 2a in the housing 2, on the −Z direction side of the stopper 41. A rotation axis 42a is provided at one end of the lever portion 42, and the lever portion 42 is rotatable around the rotation axis 42a. The other end of the lever portion 42 is in contact with the stopper 41. Specifically, the upper surface of the lever portion 42 is in contact with the lower surface of the stopper 41, and the lever portion 42 supports the stopper 41. Note that the position of the stopper 41 at which the lever portion 42 comes into contact with the stopper 41 is not limited to the lowermost end of the stopper 41. For example, when a protruding portion is formed at an intermediate position in the ±Z directions of the stopper 41, the lower surface of the protruding portion may be used. That is, the lever portion 42 may come into contact with a surface, of the stopper 41, facing downward.

The eccentric cam 43 is disposed on the −Z direction side of the lever portion 42. The eccentric cam 43 is attached to a shaft-shaped cam shaft 43a, and is rotatable together with the cam shaft 43a about the cam shaft 43a serving as a rotation axis. The cam shaft 43a is rotatably supported by a structure (not illustrated) in the housing 2. The outer peripheral surface of the eccentric cam 43 comes into contact with the lower surface of the lever portion 42. When viewed from the ±X directions, the distance from the central axis of the cam shaft 43a to the outer peripheral surface of the eccentric cam 43 changes depending on the position in the circumferential direction. Therefore, when the eccentric cam 43 rotates, the lever portion 42 rotates within a predetermined angle range. The rotation of the lever portion 42, that is, a change in the posture of the lever portion 42 causes the stopper 41 to be displaced in the up-down directions.

The driving unit 44 is coupled to the cam shaft 43a of the eccentric cam 43. The driving unit 44 includes a driving device such as a motor (not illustrated) and a toothed gear that transmits a driving force of the driving device, and rotates the eccentric cam 43. Note that the restricting unit 40 may include a dedicated driving device, or may transmit a driving force of a driving device that drives the transport unit 20 via a clutch mechanism or the like.

The rotation of the eccentric cam 43 by the driving unit 44 is controlled by the control unit 30. That is, the control unit 30 can switch the position of the stopper 41 between the restricting position and the retracted position by controlling the rotation of the eccentric cam 43. In other words, the driving unit 44 displaces the stopper 41 by rotating the eccentric cam 43 based on the control of the control unit 30. Specifically, the driving unit 44 rotates the eccentric cam 43 to rotate the lever portion 42 to cause the stopper 41 to be raised, thereby displacing the stopper 41 to the restricting position. Further, the driving unit 44 rotates the eccentric cam 43 to rotate the lever unit 42 to cause the stopper 41 to be lowered, thereby displacing the stopper 41 to the retracted position.

When the transport unit 20 is not transporting the medium M, the control unit 30 displaces the stopper 41 to the restricting position. At this time, the user can place the medium M at an appropriate position in the manual insertion feed unit 8, by inserting the medium M until the medium M comes into contact with the stopper 41 in the manual insertion feed unit 8. Further, when printing is performed on the medium M placed in the manual insertion feed unit 8 or on the medium M stored in the medium storage cassette 5, before the transport unit 20 starts transporting the medium M, the control unit 30 controls the driving unit 44 to displace the stopper 41 to the retracted position. Then, after the transport of the medium M is completed, the control unit 30 displaces the stopper 41 to the restricting position once again.

As described above, according to the printer 1 of this embodiment, the following advantages can be obtained.

According to this embodiment, the movement of the medium M manually inserted into the manual insertion feed unit 8 is restricted by the restricting unit 40. Therefore, by inserting the medium M until it is restricted by the restricting unit 40, the user can easily place the medium M at an appropriate position, and the user does not need to re-set the medium M.

Further, according to this embodiment, since the movement of the medium M manually inserted into the manual insertion feed unit 8 is restricted by the stopper 41 being displaced to the restricting position, the medium M is easily placed at an appropriate position. Further, since the restriction is released by the stopper 41 being displaced to the retracted position, the medium M can be transported to the position facing the ejection head 11.

Further, according to this embodiment, since the position of the stopper 41 is displaced by the rotation of the eccentric cam 43, the position of the stopper 41 can be easily switched between the restricting position and the retracted position.

Further, according to this embodiment, the lever portion 42 is rotated by the rotation of the eccentric cam 43, and the stopper 41 is moved up and down by the rotation of the lever portion 42. Therefore, the displacement amount of the stopper 41 can be appropriately adjusted in accordance with the position at which the lever portion 42 and the stopper 41 come into contact with each other and the position at which the lever portion 42 and the eccentric cam 43 come into contact with each other.

Further, according to this embodiment, since the stopper 41 is disposed between the first roller pair 22 and the second detector 32, the downstream end portion of the medium M manually inserted into the manual insertion feed unit 8 is positioned between the first roller pair 22 and the second detector 32. As a result, the first roller pair 22 can transport the manually inserted medium M, and the second detector 32 can detect the downstream end portion of the medium M in the process of transporting the manually inserted medium M.

Note that the number of stoppers 41 may be two or more. In this case, for example, the stoppers 41 are arranged side by side at intervals along the X-axis. Further, the stoppers 41 are configured to be displaceable between the restricting position and the retracted position in a synchronized manner. With this configuration, when the user inserts the medium M toward the stopper 41, since the medium M is restricted in a state in which an end side of the medium M is in contact with the plurality of stoppers 41, the medium M can be placed at an appropriate position in a state in which the skew of the medium M is suppressed.

### 2. Second Embodiment

Next, a second embodiment will be described.

The printer 1 according to this embodiment includes a restricting unit 40A different from the restricting unit 40 according to the first embodiment. The restricting unit 40A of this embodiment is different from the restricting unit 40 of the first embodiment in that the position of the stopper 41 is switched in conjunction with the opening and closing of the back cover 7. Other configurations of the restricting unit 40A are the same as those of the first embodiment, and description thereof will thus be omitted.

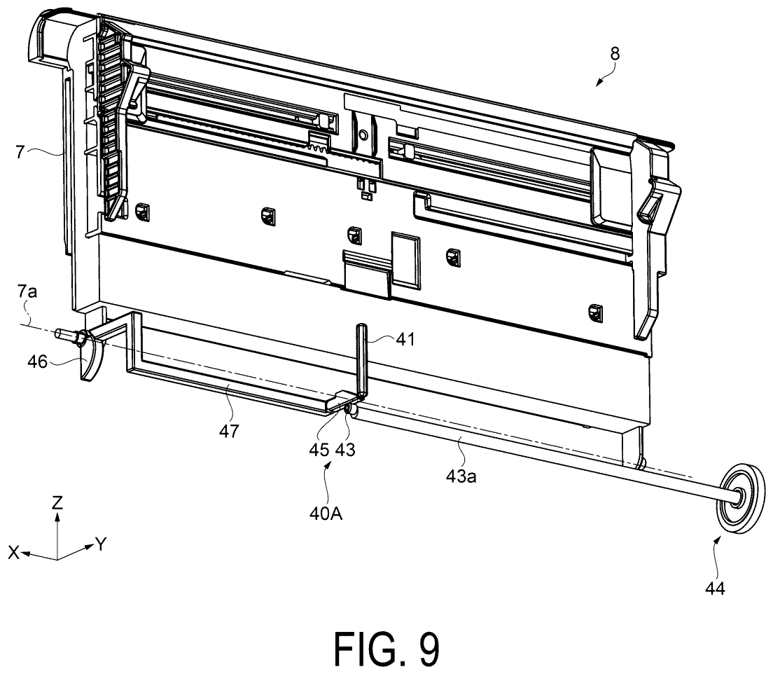

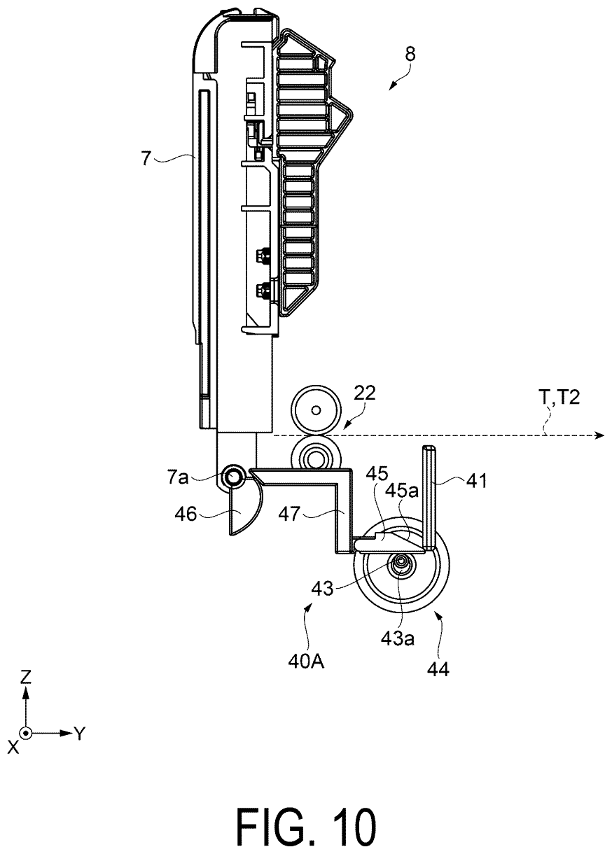

FIG. 9 is a perspective view illustrating the restricting unit 40A of this embodiment, and FIG. 10 is a side view illustrating the restricting unit 40A. These drawings illustrate a state in which the back cover 7 is closed, and both drawings also illustrate the back cover 7 and the manual insertion feed unit 8 in addition to the restricting unit 40A.

As illustrated in FIGS. 9 and 10, the restricting unit 40A of this embodiment includes the stopper 41, a lever portion 45, the eccentric cam 43, the driving unit 44, an interlocking cam 46, and a cam link 47. Among them, the stopper 41, the eccentric cam 43, and the driving unit 44 have the same configurations as those of the first embodiment.

The interlocking cam 46 is disposed on the −Z direction side of the back cover 7 and on the +X direction side of the back cover 7, in the state in which the back cover 7 is closed. The interlocking cam 46 is fixed to the back cover 7. Therefore, when the back cover 7 is opened and closed, the interlocking cam 46 rotates around a rotation axis 7a of the back cover 7 in conjunction with the opening and closing of the back cover 7.

In the state in which the back cover 7 is closed, the interlocking cam 46 extends in the −Z direction. Further, the interlocking cam 46 has an arc-shaped outer peripheral surface that is convex in the +Y direction. The outer peripheral surface of the interlocking cam 46 is eccentric with respect to the rotation axis 7a, and the distance from the rotation axis 7a to the outer peripheral surface increases toward the −Z direction.

The cam link 47 is formed in a shape obtained by bending a rectangular column-shaped member a plurality of times. One end of the cam link 47 comes into contact with the outer peripheral surface of the interlocking cam 46. The cam link 47 extends in the +Y direction, and subsequently extends in the −Z direction, the −X direction, and the +Y direction, in this order, from one end to the other end thereof. The cam link 47 is movable in the ±Y directions, but the movement of the cam link 47 in other directions is restricted by a structure (not illustrated) or the like in the housing 2. Further, the cam link 47 is biased in the −Y direction by a biasing unit (not illustrated). That is, the one end of the cam link 47 is pressed against the outer peripheral surface of the interlocking cam 46. The cam link 47 is an example of a link member.

The lever portion 45 of this embodiment is attached to the other end side of the cam link 47. That is, the cam link 47 is interposed between the interlocking cam 46 and the lever portion 45. The lever portion 45 is a member extending along the Y-axis, and is rotatably supported by the cam link 47 at an end portion thereof on the −Y direction side. The lever portion 45 has, at an end portion thereof on the +Y direction side, an inclined surface 45a that slopes down toward the +Y direction, and the lever portion 45 comes into contact with the lower surface of the stopper 41 at the inclined surface 45a. In the state in which the back cover 7 is closed, the lower surface of the stopper 41 is in contact with the end portion of the lever portion 45 on the +Y direction side, that is, a relatively low portion of the inclined surface 45a. The +Y direction is an example of a first direction.

Similarly to the lever portion 42 of the first embodiment, the lower surface of the lever portion 45 comes into contact with the outer peripheral surface of the eccentric cam 43. Then, when the eccentric cam 43 rotates under the control of the control unit 30, the lever 45 rotates within a predetermined angle range. By the rotation of the lever portion 45, the stopper 41 is displaced in the up-down directions. In this embodiment, in the state in which the back cover 7 is closed, the control unit 30 causes a portion of the outer peripheral surface of the eccentric cam 43 to come into contact with the lower surface of the stopper 41, at a section at which the position of the stopper is highest. However, in the state in which the back cover 7 is closed, the lower surface of the stopper 41 is in contact with the relatively low portion of the inclined surface 45a of the lever portion 45, and thus the stopper 41 does not reach the restricting position. That is, the stopper 41 is located at the retracted position.

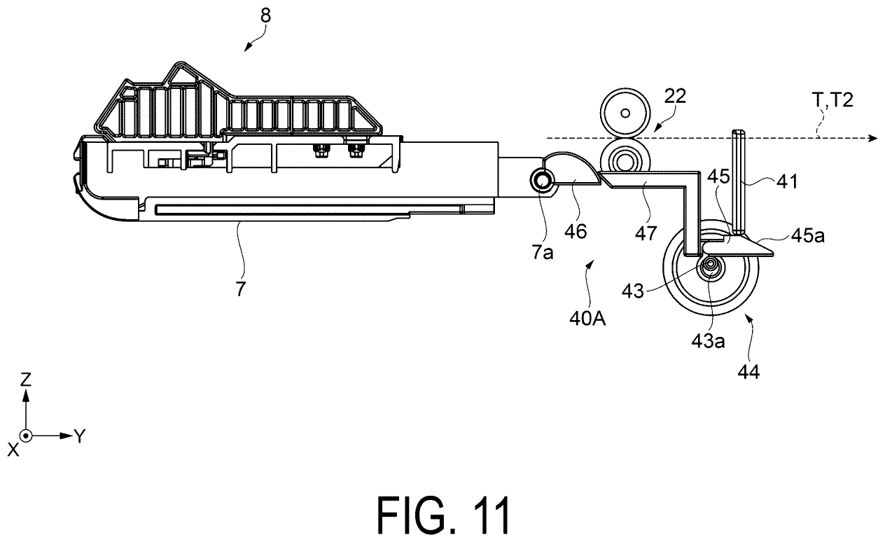

FIG. 11 is a side view illustrating the restricting unit 40A in the state in which the back cover 7 is open.

As illustrated in FIG. 11, when the back cover 7 is opened, the interlocking cam 46 rotates at the same time. As a result, the posture of the interlocking cam 46 changes from a posture extending in the −Z direction to a posture extending in the +Y direction. Therefore, the cam link 47 is pressed in the +Y direction by the interlocking cam 46. When the cam link 47 is pressed by the interlocking cam 46 and moves in the +Y direction, the lever portion 45 also moves in the +Y direction together with the cam link 47. That is, when the back cover 7 is opened, the interlocking cam 46 presses the lever portion 45 in the +Y direction via the cam link 47. Then, when the lever portion 45 moves in the +Y direction, the stopper 41 moves upward along the inclined surface 45a and is displaced to the restricting position. As described above, in this embodiment, the stopper 41 is displaced from the retracted position to the restricting position in conjunction with the opening of the back cover 7.

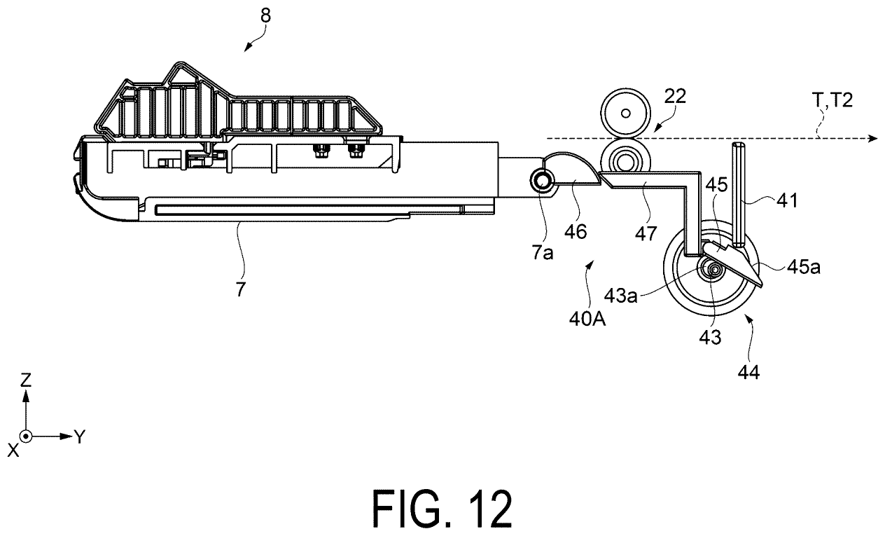

FIG. 12 is a side view illustrating the restricting unit 40A, and illustrates a state in which the stopper 41 is displaced to the retracted position in the state in which the back cover 7 is open.

As illustrated in FIG. 12, the control unit 30 can displace the stopper 41 to the retracted position by changing the posture of the lever portion 45 by controlling the driving unit 44 to rotate the eccentric cam 43. That is, when the driving unit 44 rotates the eccentric cam 43 to rotate the lever portion 45 to cause the stopper 41 to be lowered, the stopper 41 is displaced to the retracted position. In this way, the control unit 30 can switch the position of the stopper 41 between the restricting position and the retracted position, in the state in which the back cover 7 is open.

That is, in this embodiment, when the user opens the back cover 7, the stopper 41 is displaced to the restricting position. At this time, the user can place the medium M at an appropriate position in the manual insertion feed unit 8, by inserting the medium M until the medium M comes into contact with the stopper 41 in the manual insertion feed unit 8. Further, when printing is performed on the medium M placed in the manual insertion feed unit 8 or on the medium M stored in the medium storage cassette 5, before the transport unit 20 starts transporting the medium M, the control unit 30 controls the driving unit 44 to displace the stopper 41 to the retracted position. Then, after the transport of the medium M is completed, the control unit 30 displaces the stopper 41 to the restricting position once again.

Thereafter, when the back cover 7 is closed, the cam link 47 moves in the −Y direction together with the lever portion 45. Then, when the lever portion 45 moves in the −Y direction, the stopper 41 is lowered along the inclined surface 45a and is displaced to the retracted position. Therefore, in this embodiment, the control unit 30 does not need to control the displacement of the stopper 41 in the state in which the back cover 7 is closed.

As described above, according to the printer 1 of this embodiment, the following advantages can be obtained.

According to this embodiment, since the stopper 41 is displaced to the restricting position in conjunction with the opening of the back cover 7, when the back cover 7 is opened and the medium M is manually inserted into the manual insertion feed unit 8, the movement of the medium M can be reliably restricted.

### 3. Third Embodiment

Next, a third embodiment will be described.

The printer 1 according to this embodiment includes a restricting unit 40B different from the restricting unit 40 according to the first embodiment and the restricting unit 40A according to the second embodiment. Similarly to the restricting unit 40A of the second embodiment, the restricting unit 40B of this embodiment displaces the stopper 41 to the restricting position in conjunction with the opening of the back cover 7. However, the stopper 41 of the restricting unit 40B is different from that of the restricting unit 40A in that the stopper 41 is switched from the restricting position to the retracted position without being controlled by the control unit 30. Other configurations of the restricting unit 40B are the same as those of the second embodiment, and description thereof will thus be omitted.

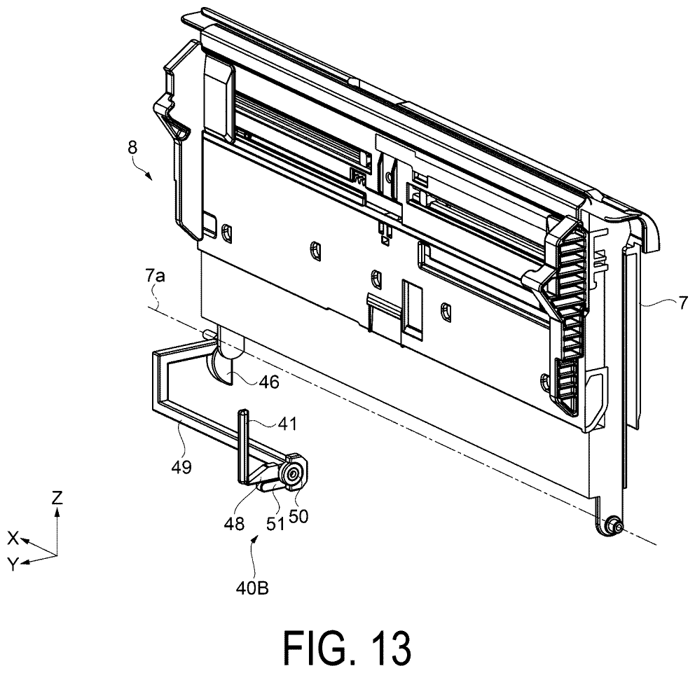

FIG. 13 is a perspective view illustrating the restricting unit 40B of this

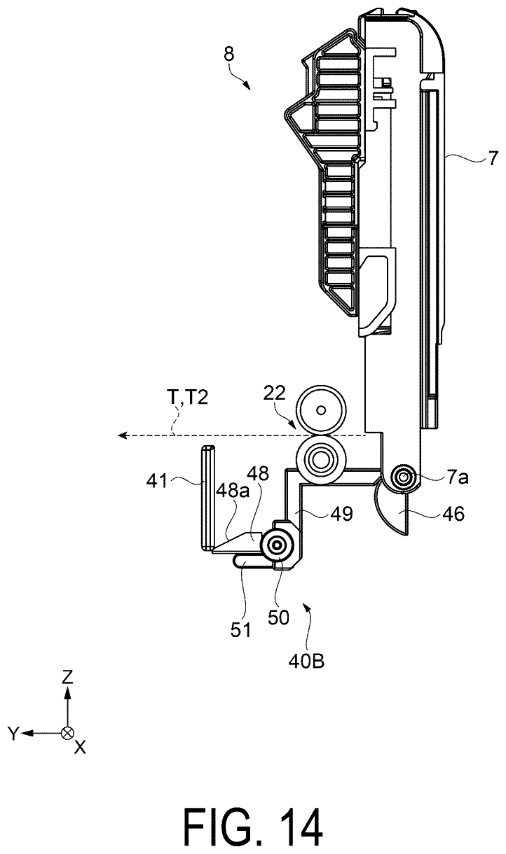

embodiment, and FIG. 14 is a side view illustrating the restricting unit 40B. These drawings illustrate the state in which the back cover 7 is closed, and both drawings also illustrate the back cover 7 and the manual insertion feed unit 8 in addition to the restricting unit 40B.

As illustrated in FIGS. 13 and 14, the restricting unit 40B of this embodiment includes the stopper 41, a lever portion 48, the interlocking cam 46, a cam link 49, a damper 50, and a lever support portion 51. The restricting unit 40B of this embodiment does not include the eccentric cam 43 and the driving unit 44. Further, the stopper 41 and the interlocking cam 46 have the same configurations as those of the second embodiment.

The cam link 49 has the same configuration as that of the cam link 47 of the second embodiment, but is different from the cam link 47 of the second embodiment in that the damper 50 is fixed to the other end side. That is, the cam link 49 is interposed between the interlocking cam 46 and the damper 50. The cam link 49 is an example of the link member.

The damper 50 is, for example, a rotary damper, and rotatably supports the lever portion 48.

The lever portion 48 is a member extending along the Y-axis similarly to the lever portion 45 of the second embodiment, and is rotatably supported by the damper 50 at an end portion thereof on the −Y direction side. The lever portion 48 has, at an end portion thereof on the +Y direction side, an inclined surface 48a that slopes down toward the +Y direction side, and the lever portion 48 comes into contact with the lower surface of the stopper 41 at the inclined surface 48a. In the state in which the back cover 7 is closed, the lower surface of the stopper 41 is in contact with the end portion of the lever portion 48 on the +Y direction side, that is, a relatively low portion of the inclined surface 48a.

The lever support portion 51 is disposed below the lever portion 48. The lever support portion 51 is fixed to a structure (not illustrated) in the housing 2, and the movement of the lever support portion 51 is restricted in each direction. The lever support portion 51 supports the lever portion 48 and restricts the lever portion 48 not to rotate due to its own weight and the weight of the stopper 41. The lever support portion 51 is an example of a support portion.

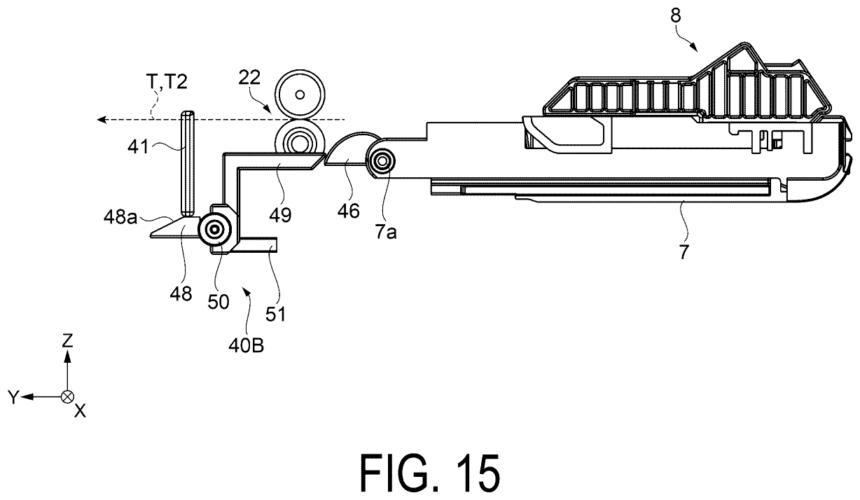

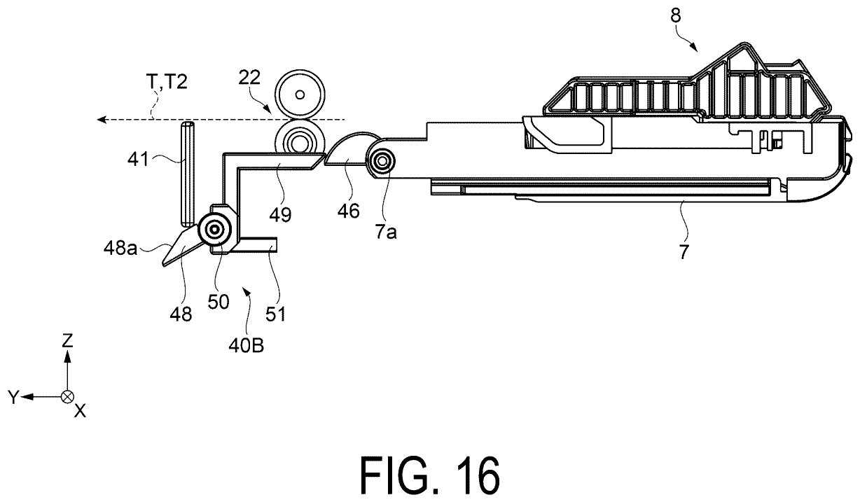

FIG. 15 is a side view illustrating the restricting unit 40B in a state immediately after the back cover 7 is opened. FIG. 16 is a side view illustrating the restricting unit 40B, and is a view illustrating a state after a predetermined time period has elapsed since the back cover 7 was opened.

As illustrated in FIG. 15, when the back cover 7 is opened, the interlocking cam 46 rotates at the same time. As a result, the posture of the interlocking cam 46 changes from a posture extending in the −Z direction to a posture extending in the +Y direction. Therefore, the cam link 49 is pressed in the +Y direction by the interlocking cam 46. When the cam link 49 is pressed by the interlocking cam 46 and moves in the +Y direction, the damper 50 and the lever portion 48 also move in the +Y direction together with the cam link 49. That is, when the back cover 7 is opened, the interlocking cam 46 presses the damper 50 in the +Y direction via the cam link 49, and moves the damper 50 and the lever portion 48 in the +Y direction. Then, when the lever portion 48 moves in the +Y direction together with the damper 50, the stopper 41 moves upward along the inclined surface 48a and is displaced to the restricting position. In this way, in this embodiment, the stopper 41 is displaced to the restricting position in conjunction with the opening of the back cover 7.

On the other hand, when the lever portion 48 moves in the +Y direction as described above, the position of the lever portion 48 is a position that does not overlap the lever support portion 51 when viewed from the ±Z directions. Therefore, as illustrated in FIG. 16, when the lever portion 48 moves in the +Y direction, the lever portion 48 is released from the restriction of the lever support portion 51 and rotates due to its own weight and the weight of the stopper 41. Here, the rotation angle of the lever portion 48 is restricted to a predetermined angle by a restricting unit (not illustrated). Then, when the lever portion 48 is rotated by the predetermined angle, the stopper 41 is lowered and displaced to the retracted position.

Here, since the lever portion 48 is supported by the damper 50, the lever portion 48 rotates slowly over time after being released from the restriction of the lever support portion 51. That is, after a predetermined time period has elapsed since the back cover 7 was opened and the stopper 41 was displaced to the restricting position, the stopper 41 is naturally displaced to the retracted position. The predetermined time period until the stopper 41 is displaced to the retracted position depends on the specification or the like of the damper 50. However, for example, it is desirable that the stopper 41 remains at a position at which the movement of the medium M can be restricted for about five seconds.

As described above, according to the printer 1 of this embodiment, the following advantages can be obtained.

According to this embodiment, since the stopper 41 is displaced to the restricting position in conjunction with the opening of the back cover 7, when the back cover 7 is opened and the medium M is manually inserted into the manual insertion feed unit 8, the movement of the medium M can be reliably restricted. Further, when the stopper 41 is displaced to the restricting position, the lever portion 48 that is in contact with the lower surface of the stopper 41 is released from the restriction of the lever support portion 51 and rotates. As a result, the stopper 41 is naturally displaced to the retracted position. Therefore, it is not necessary to use a driving unit to displace the stopper 41 to the retracted position. Here, since the lever portion 48 is supported by the damper 50, the stopper 41 is inhibited from being lowered to the retracted position immediately after being displaced to the restricting position. Therefore, when the medium M is manually inserted into the manual insertion feed unit 8, the movement of the medium M can be restricted.

Although this embodiment is basically assumed to have the configuration described above, it goes without saying that modification, omission, and the like of part of the configuration is possible within a range that does not deviate from the scope and gist of the present disclosure. Further, the embodiments described above and modified examples to be described below can be combined with each other as long as no technical contradiction arises due to the combination. Hereinafter, modified examples will be described.

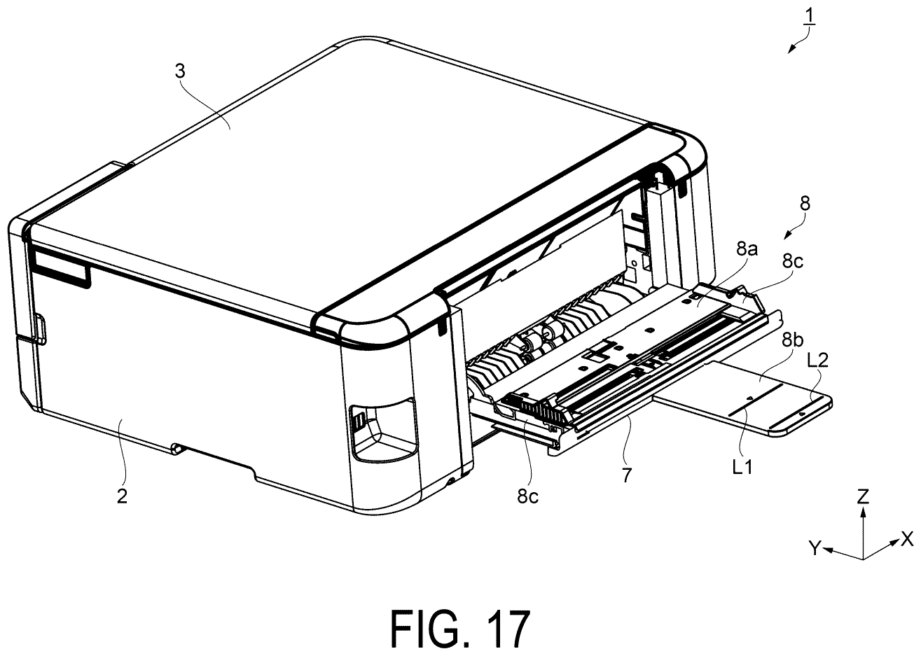

As illustrated in FIG. 17, in each of the embodiments described above, it is desirable that an auxiliary line L for designating a position at which the medium M is to be placed is displayed on the placement surface 8a including the upper surface of the auxiliary plate 8b, in accordance with the size of the medium M that is frequently used. The auxiliary line L may include, for example, a first auxiliary line L1 indicating the position of the upstream end portion of the medium M when the medium M is placed at an appropriate position, and a second auxiliary line L2 indicating the position of the upstream end portion of the medium M when the medium M is placed at an upstream limit position at which the medium M can be normally transported. In addition, the auxiliary line L may include a third auxiliary line indicating the position of the upstream end portion of the medium M when the medium M is placed at a downstream limit position at which the medium M can be normally transported. According to this configuration, since the auxiliary line L for designating the position at which the medium M is to be placed is displayed on the placement surface 8a of the manual insertion feed unit 8, the user can also visually recognize whether or not the medium M is placed at an appropriate position in the manual insertion feed unit 8, in addition to the restriction by the restriction unit 40.

In the configuration in which the stopper 41 is displaced to the restricting position in conjunction with the opening of the back cover 7, as in the second embodiment and the third embodiment described above, the medium M may interfere with the stopper 41, for example, when the back cover 7 is opened while the medium M fed from the medium storage cassette 5 is being transported. Thus, it is desirable that the printer 1 includes an opening restricting unit that restricts opening of the back cover 7 in the state in which the back cover 7 is closed. According to this configuration, since the back cover 7 is not opened while the medium M fed from the medium storage cassette 5 is being transported, it is possible to inhibit the medium M from interfering with the stopper 41. The opening restricting unit may be, for example, a lock mechanism that switches between a locked state in which the opening of the back cover 7 is restricted and a non-locked state in which the back cover 7 can be opened, based on the control of the control unit 30. In this case, the control unit 30 may bring the back cover 7 into the locked state while the medium M fed from the medium storage cassette 5 is being transported, and may bring the back cover 7 into the non-locked state after the transport of the medium M is completed or when the upstream end portion of the medium M is detected by the second detector 32.

Further, in the second embodiment described above, at least while the medium M fed from the medium storage cassette 5 is being transported, the control unit 30 may rotate the eccentric cam 43 to rotate the lever portion 45 to cause the stopper 41 to be lowered. In this case, even if the back cover 7 is opened and the stopper 41 is raised while the medium M is being transported, the stopper 41 does not reach the restricting position, and thus the medium M does not interfere with the stopper 41.

In the first embodiment and the second embodiment described above, the driving unit 44 rotates the eccentric cam 43, and the eccentric cam 43 rotates the lever portion 42, 45 to displace the stopper 41 in the up-down directions. However, the configuration is not limited to this configuration. For example, the stopper 41 may be disposed on the eccentric cam 43, and the eccentric cam 43 may directly displace the stopper 41 in the up-down directions without using the lever portion 42, 45.

In the restricting unit 40A of the second embodiment described above, when the back cover 7 is opened, the interlocking cam 46 presses the lever portion 42 in the +Y direction via the cam link 47. Further, in the restricting unit 40B of the third embodiment described above, when the back cover 7 is opened, the interlocking cam 46 presses the damper 50 in the +Y direction via the cam link 49. However, the configuration of the restricting unit 40A, 40B is not limited to this configuration, and the interlocking cam 46 may be configured to directly press the lever portion 42 or the damper 50 without using the cam link 47, 49.

In each of the embodiments described above, the configuration in which the manual insertion feed unit 8 is disposed on the back side of the back cover 7 is illustrated, but the configuration of the manual insertion feed unit 8 is not limited to this configuration. For example, the manual insertion feed unit 8 may be configured to be housed inside the housing 2 in the state in which the back cover 7 is closed and to be pulled out in the −Y direction after the back cover 7 is opened. Alternatively, the manual insertion feed unit 8 may always protrude in the −Y direction, and the placement surface 8a may be covered with a cover member that can be opened and closed. Then, the manual insertion feed unit 8 may be configured to become usable when the cover member is opened. In this case, the cover member corresponds to an opening/closing portion. That is, the opening/closing portion may be configured such that the manual insertion feed unit 8 cannot be used when the opening/closing portion is closed, and the manual insertion feed unit 8 can be used when the opening/closing portion is open.

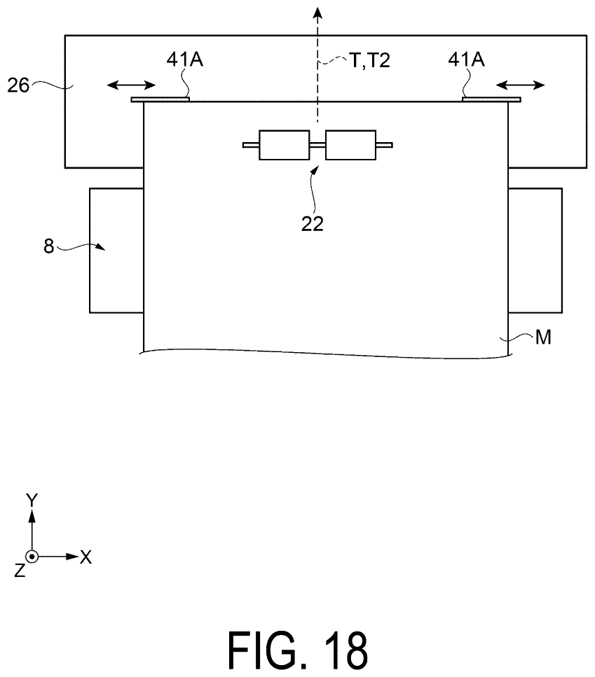

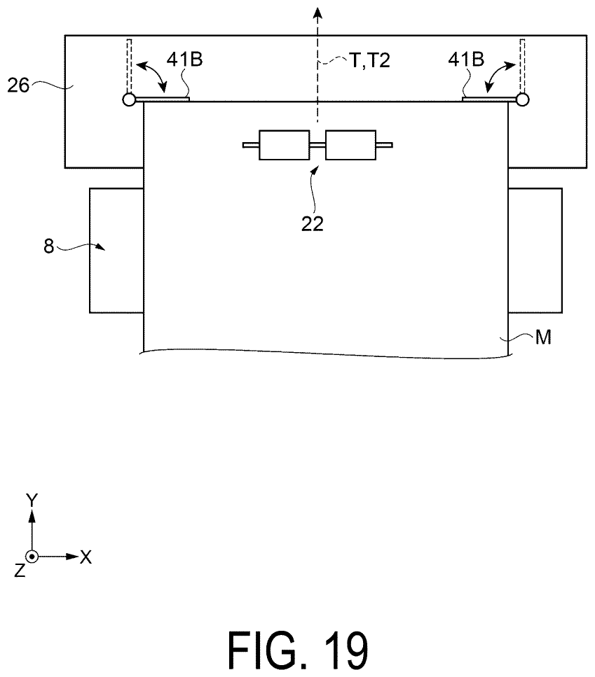

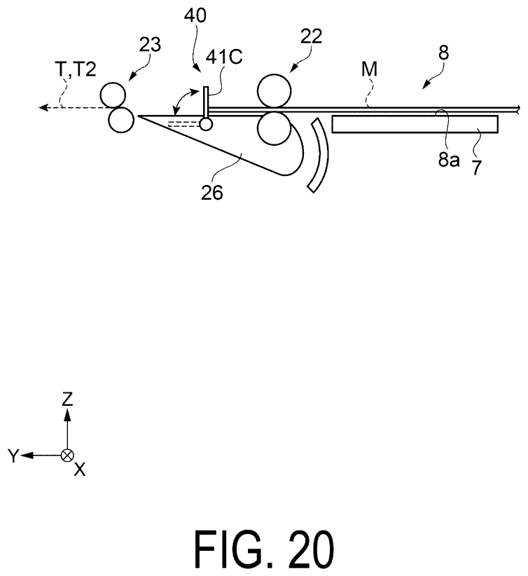

In each of the embodiments described above, a mode is described in which the movement of the medium M is restricted by raising the stopper 41 that is movable in the up-down directions, but the mode of the stopper 41 is not limited to the mode described above. For example, the movement of the medium M may be restricted by the stopper 41 being lowered from the retracted position located above the transport path T. Further, as illustrated in FIG. 18, a stopper 41A that is movable in the ±X directions may be provided on at least one of the +X direction side and the −X direction side of the transport path T. Further, as illustrated in FIG. 19, a stopper 41B that is rotatable around a rotation axis along the Z-axis may be provided on at least one of the +X-direction side and the −X-direction side of the transport path T, or as illustrated in FIG. 20, a stopper 41C that is rotatable around a rotation axis along the X-axis may be disposed above or below the transport path T. Although not illustrated, a stopper that is rotatable about a rotation axis along the Y-axis may be disposed above or below the transport path T.

In the embodiments described above, the printer 1 is a device that forms an image on the medium M, and may be a serial printer, a lateral printer, a line printer, a page printer, or the like. Further, a printing method is not limited to the inkjet method, and a thermal method, a dot-impact method, a laser method, or the like may be employed.

What is claimed is:

1. An image forming device comprising:
a transport path along which a medium is transported;
a transport unit configured to transport the medium in a transport direction along the transport path;
an image forming unit configured to form an image on the medium transported along the transport path;
a manual insertion feed unit configured to feed the manually inserted medium onto the transport path;
a discharge tray disposed downstream of the transport path in the transport direction and on which the medium discharged from the transport path is placed; and
a restricting unit configured to restrict, at a position upstream, in the transport direction, of a position facing the image forming unit on the transport path, a downstream movement of the medium manually inserted into the manual insertion feed unit.

2. The image forming device according to claim 1, wherein
the restricting unit includes a stopper that is displaceable between a first position at which the downstream movement of the medium is restricted, and a second position at which the downstream movement of the medium is not restricted.

3. The image forming device according to claim 2, wherein
the restricting unit includes
an eccentric cam, and
a driving unit configured to rotate the eccentric cam, and
the driving unit displaces the stopper by rotating the eccentric cam.

4. The image forming device according to claim 3, wherein
the restricting unit includes a lever portion that is rotatable and comes into contact with a lower surface of the stopper,
the eccentric cam comes into contact with a lower surface of the lever portion, and
the driving unit
displaces the stopper to the first position by rotating the eccentric cam to rotate the lever portion to cause the stopper to be raised, and
displaces the stopper to the second position by rotating the eccentric cam to rotate the lever portion to cause the stopper to be lowered.

5. The image forming device according to claim 2, comprising
an opening/closing portion configured to be opened and closed with respect to an outer casing of the image forming device, and to cover the manual insertion feed unit when the opening/closing portion is closed, wherein
the stopper is displaced from the second position to the first position in conjunction with opening of the opening/closing portion.

6. The image forming device according to claim 5, wherein
the restricting unit includes
a lever portion that is rotatable, includes an inclined surface, and is configured to come into contact with a lower surface of the stopper at the inclined surface, the inclined surface sloping downward in a first direction intersecting a vertical direction, at an end portion of the lever portion on a side of the first direction,
an eccentric cam configured to come into contact with a lower surface of the lever portion,
a driving unit configured to rotate the eccentric cam, and
an interlinking cam configured to rotate in conjunction with opening and closing of the opening/closing portion,
the stopper is displaced to the first position when the opening of the opening/closing portion causes the interlinking cam to rotate to press and move the lever portion in the first direction, and
the stopper is displaced to the second position when the driving unit rotates the eccentric cam to rotate the lever portion to cause the stopper to be lowered.

7. The image forming device according to claim 6, wherein
the restricting unit includes a link member interposed between the interlinking cam and the lever portion, and
the interlinking cam presses the lever portion via the link member when the opening/closing portion is opened.

8. The image forming device according to claim 5, wherein
the restricting unit includes
a lever portion that includes an inclined surface and is configured to come into contact with a lower surface of the stopper at the inclined surface, the inclined surface sloping downward in a first direction intersecting a vertical direction, at an end portion of the lever portion on a side of the first direction,
a damper configured to rotatably support the lever portion,
a support portion configured to support the lever portion and restrict rotation of the lever portion, and
an interlinking cam configured to rotate in conjunction with opening and closing of the opening/closing portion,
when the opening of the opening/closing portion causes the interlinking cam to rotate to press the damper in the first direction and move the lever portion in the first direction together with the damper, the stopper is raised along the inclined surface and displaced to the first position, and
when the lever portion is released from the restriction of the support portion as a result of the lever portion moving in the first direction, and rotates under its own weight, the stopper is lowered by the rotation of the lever portion and displaced to the second position.

9. The image forming device according to claim 8, wherein
the restricting unit includes a link member interposed between the interlinking cam and the damper, and
the interlinking cam presses the damper via the link member when the opening/closing portion is opened.

10. The image forming device according to claim 5, further comprising
an opening restricting unit configured to restrict opening of the opening/closing portion when the opening/closing portion is closed.

11. The image forming device according to claim 2, further comprising
a medium detector disposed upstream of the position facing the image forming unit on the transport path and configured to detect a downstream end portion of the medium, wherein
the transport unit includes a transport roller pair disposed upstream of the medium detector, and
the stopper is disposed between the transport roller pair and the medium detector.

12. The image forming device according to claim 1, wherein
the manual insertion feed unit includes a placement surface on which the medium is placed, and
an auxiliary line designating a position at which the medium is to be placed is displayed on the placement surface.
